(19) United States
(12) Patent Application Publication
(10) Pub. No.: US 2009/0144991 A1
(43) Pub. Date: Jun. 11, 2009

(54) Multi-Component Eating Utensil

(75) Inventors: Blake Synnestvedt, Birmingham, MI (US); Bradley McCardell, Rochester, MI (US)

Correspondence Address: MAGINOT, MOORE & BECK, LLP;CHASE TOWER, 111 MONUMENT CIRCLE, SUITE 3250, INDIANAPOLIS, IN, 46204, US

(73) Assignee: INNATECH, LLC, Rochester, MI (US)

(21) Appl. No.: 12/329,988

(22) Filed: Dec. 8, 2008

Related U.S. Application Data
(60) Provisional application No. 61/005,709, filed on Dec. 7, 2007.

(51) Int. Cl. A47J 43/28

(52) U.S. Cl. 30/324

(57) ABSTRACT

An articulating eating utensil consists of a utensil head, a shaft, and a handle. The utensil head and the handle are formed of a first material, and the shaft is formed of a second material. The utensil head is provided as the bowl of a spoon, the tines of a fork, a spatula, or any other utensil head useful in handling food for consumption. In a first configuration, the shaft is retracted within an interior cavity of the handle and the utensil head is pivoted toward the handle, such that the eating utensil is a small and lightweight instrument. In a second configuration, the utensil head is pivoted away from the handle and the shaft is extended from the interior cavity of the handle, such that the eating utensil functions like a traditional non-articulating eating utensil.

### CROSS REFERENCE TO RELATED APPLICATION

This application claims priority from U.S. Provisional Application No. 61/005,709 filed on Dec. 7, 2007.

### TECHNICAL FIELD

The present invention relates generally to eating utensils, and particularly to eating utensils having an articulating food handling utensil head and an extendable handle.

### BACKGROUND

It is common to purchase food products ready for consumption in portable containers. Examples include soups, pastas, yogurt, and many others. Most of these products require an eating utensil to simplify consumption; however, they are often sold without a suitable utensil. There are numerous reasons why manufacturers choose not include an accompanying eating utensil along with portable food products.

First, inclusion of an eating utensil ultimately increases the retail price of the food product. As is well known, manufacturers strive to sell products at the lowest possible retail price at which an acceptable profit can be generated. Thus, by forcing purchasers to supply their own eating utensils, manufactures are able to reduce the cost per unit of each food product, resulting in a lower retail price. Of course, consumers benefit from the lower price; however, some consumers may feel the lower price does not compensate for the inconvenience of having to supply an eating utensil.

Second, the size of some portable food products makes packaging traditional eating utensils with portable food products difficult for manufacturers. For example, consider a portable soup container or a yogurt product. Often, the containers in which these products are sold do not have a dimension equal to or greater than the length of a traditional plastic eating utensil. Thus, if a manufacturer were to include a traditional eating utensil with these products, the utensil would very likely protrude from the container thereby making packaging and displaying the product prohibitively difficult.

Third, some manufactures do not include eating utensils with portable food products because currently available disposable eating utensils are of such a low quality that many consumers opt not to use them even when they are provided. For example, some disposable spoons are often too pliable to support a full bowl of hot food product. Likewise, the tines of some disposable forks are too pliable to adequately pierce a food product. Furthermore, some consumers may find currently available disposable eating utensils uncomfortable to use. Specifically, some eating utensils have sharp or irregular edges that might irritate a user's mouth. Of course, high strength and comfortable eating utensils are available; however, as previously mentioned, the cost and size of these products prohibits manufacturers from including them with the sale of most portable food products.

In view of the foregoing, it would be advantageous to provide a sturdy and comfortable eating utensil for consuming portable food products. It would also be advantageous to provide a compact eating utensil that can be easily packaged with most portable food products, regardless of the package size. Furthermore, it would be advantageous if the eating utensil was inexpensive and simple to manufacture.

### SUMMARY

A new eating utensil includes a utensil head, a shaft, and a handle end. The utensil head is pivotally connected to a first end of the shaft, such that the utensil head articulates between an unfolded and a folded position. The utensil head may include a spoon bowl, fork tines, a spatula, or the like depending on the food product that it accompanies. The handle surrounds a shaft, which is configured to slide between a retracted and an extended position. Therefore, the eating utensil can be arranged in at least two different configurations.

In an unfolded configuration, the shaft is extended from the handle and the utensil head is pivoted away from the handle and locked in place, such that the eating utensil takes the form of a traditional non-articulating eating utensil. A detent and a tab ensure that the utensil head remains stationary and the shaft does not retract into the handle while the eating utensil is in the unfolded configuration. The unfolded utensil remains rigid when used to consume food products. Alternatively, in a folded configuration, the shaft is retracted into the handle and the utensil head is pivoted to rest upon the handle. In the folded configuration, the eating utensil has a total length approximately thirty-three to sixty percent of the length of the eating utensil in the unfolded configuration. Thus, the folded utensil has a very small size allowing it to be packaged with a wide variety of food products.

The new eating utensil may be inexpensively formed with a two-shot sequential injection molding process. The process utilizes at least two different polymers to form the eating utensil comprised of at least two different materials. The first polymer is used to form the shaft, and the second polymer is used to form the handle and the utensil head. The two polymers are selected such that they are chemically incompatible and do not bond together during or after the molding process. Therefore, the handle material can be injected as a molten polymer around a portion of the shaft without the handle material bonding to the shaft, thus allowing the handle to slide about the shaft after the molding process when the utensil has sufficiently cooled. Similarly, the utensil head can be injected as a molten polymer around a portion of the shaft and still articulate about the shaft after the utensil has sufficiently cooled.

The above described features and advantages, as well as others, will become more readily apparent to those of ordinary skill in the art by reference to the following detailed description and accompanying drawings. While it would be desirable to provide an eating utensil that provides one or more of these or other advantageous features as may be apparent to those reviewing this disclosure, the teachings disclosed herein extend to those embodiments, which fall within the scope of the appended claims, regardless of whether they accomplish one or more of the above-mentioned advantages or include all of the above-mentioned features.

### BRIEF DESCRIPTION OF THE DRAWINGS

FIG. 1 depicts a perspective view of the eating utensil in the unfolded configuration as disclosed herein.

FIG. 2 depicts a perspective view of the eating utensil of FIG. 1 in the folded configuration.

FIG. 3 depicts a top view of the junction between the utensil head and the first shaft of the eating utensil of FIG. 1.

FIG. 4 depicts a side view of the utensil head and the first shaft of the eating utensil illustrated in FIG. 1.

FIG. 5 depicts a perspective view of the first shaft and the handle of the eating utensil of FIG. 1.

FIG. 6 depicts a bottom view of the eating utensil of FIG. 1.

FIG. 7 depicts a flowchart illustrative of a process for forming the eating utensil of FIG. 1.

FIG. 8 depicts an orthographic view of the first stage of the molding process for molding the eating utensil of FIG. 1.

FIG. 9 depicts an orthographic view of the second stage of the molding process for molding the eating utensil of FIG. 1.

FIG. 10 depicts an orthographic view of the third stage of the molding process for molding the eating utensil of FIG. 1.

### DETAILED DESCRIPTION

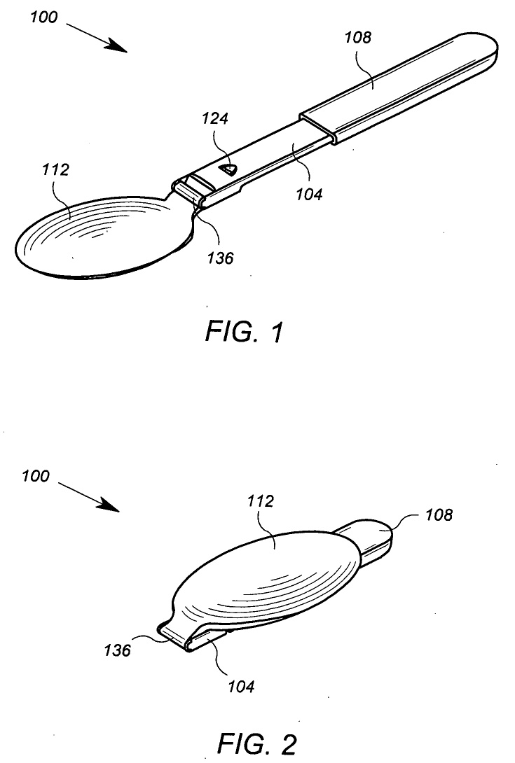

As illustrated in FIG. 1, the eating utensil 100 includes a first shaft 104 made of a first material, a second shaft provided as an handle end portion 108 made of a second material, and a utensil head 112 also made of the second material, the utensil head configured for food handling. The first shaft 104 and the second shaft 108 together form a complete handle for the eating utensil. The utensil head 112 is pivotally connected to the first end of the shaft 104. The opposite end of the shaft 104 is connected to the handle end 108, such that the shaft 104 may be extended and retracted into the handle end 108. The eating utensil 100, as illustrated in FIG. 1, is in a configuration suitable for handling food, herein termed the unfolded configuration. Whereas, the eating utensil 100, illustrated in FIG. 2, is in a compact configuration suitable for packaging with a food product, herein termed the folded configuration. In the folded configuration the utensil 100 is only thirty-three to sixty percent of the length of the utensil 100 in the unfolded configuration, thereby making the utensil 100 easy to package with food products. Below, each element of the utensil 100 and a process for manufacturing 700 are described in detail.

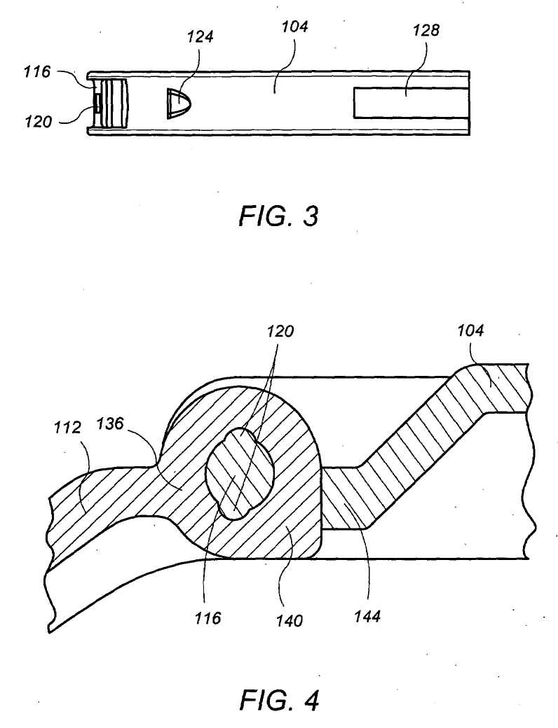

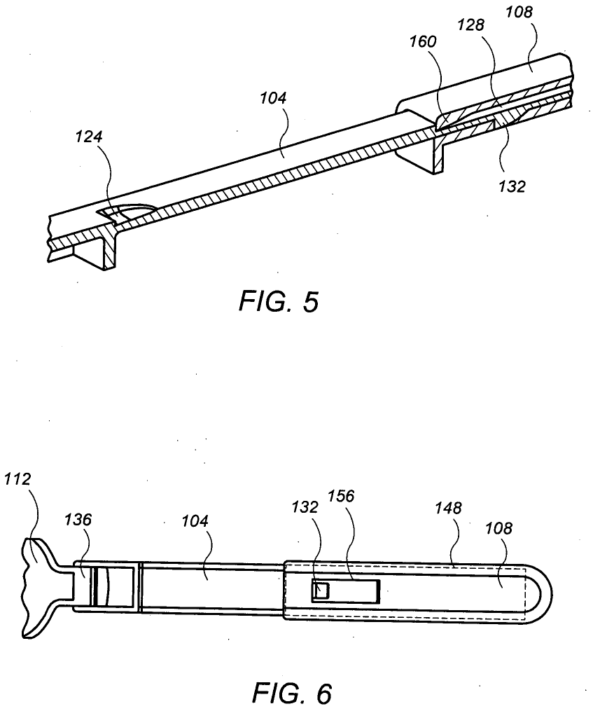

Illustrated in FIGS. 1 and 3, the shaft 104 is connected to the utensil head 112 and the handle end 108. The shaft 104 includes a pivot rod 116, one or more utensil head detents 120, a sloped depression 124, an elongated groove 128, and a handle detent 132 (FIG. 6). The pivot rod 116 is located at the end of the shaft 104 proximal the utensil head 112, and extends across the width of the shaft 104. The rod 116 has a generally circular shape, except for the utensil head detents 120, which protrude from the rod 116 approximately one to two millimeters. The utensil head detents 120 are explained below in further detail with reference to the utensil head 112. Likewise, the sloped depression 124, elongated groove 128, and handle detent 132 are described in further detail with reference to the handle end 108.

The utensil head 112, as best illustrated in the embodiment of FIG. 1, is suitable for handling food for consumption. The utensil head 112 is shown as the bowl of a spoon in the disclosed embodiments; however, other types of utensil heads 112 may also be provided including forks, knives, spatulas, and the like. Furthermore, other types of spoon bowls having various sizes may be provided including bowls with perforations or slots. The utensil head 112 is formed with a process 700 described below that ensures the edges of the utensil head 112 are free from abrasions and other irregularities that might irritating the user's mouth as food is drawn from the utensil head 112.

The utensil head 112 includes a connecting member 136 joining the utensil head 112 to the pivot rod 116, as illustrated in FIG. 4. In the disclosed embodiment, the connecting member 136 does not have an opening or slot used to attach the utensil head 112 to the pivot rod 116. Instead, the connecting member 136 completely surrounds the pivot rod 116 and the utensil head detents 120, as can be accomplished through a two-shot injection molding process, as explained in further detail below. Specifically, the connecting member 136 is formed by injecting molten polymer around the pivot rod 116 and the utensil head detents 120. Therefore, the connecting member 136 cannot be removed from the shaft 104 without destroying the functionality of the utensil 100.

As briefly mentioned above, the shaft 104 includes one or more utensil head detents 120 that stabilize the rotational position of the utensil head 112 about the pivot rod 116, as illustrated in FIG. 3. In the unfolded configuration the utensil head detents 120 and the pivot rod 116 are completely surrounded by the connecting member 136, as illustrated in FIG. 4. Thus, the utensil head detents 120 function to maintain the position of the utensil head 112 when the utensil head 112 is in the unfolded configuration. However, when the utensil head 112 is articulated to the folded position the utensil head detents 120 deform the connection member 136, thereby introducing a gap between portions of the connecting member 136 and the pivot rod 116. Therefore, the utensil head 112 and connecting member 136 should be formed of a material that can withstand the forces exerted by the utensil head detents 120 when the utensil head 112 is in the folded configuration. Suitable materials are described below in reference to the process 700 utilized to mold the utensil 100.

With continued reference to FIG. 4, the connecting member 136 includes a flat portion 140, which abuts a receiving surface 144 on the shaft 104. The receiving surface 144 is sized to form a continuous interface with the flat surface 140 when the utensil head 112 is in the unfolded configuration. The continuous surface forms a strong junction between the connecting member 136 and the shaft 104 that prevents the utensil head 112 from hyper extending beyond the degree of rotation illustrated in FIG. 4.

The handle end 108 is coupled to the end of the shaft 104 opposite the utensil head 112, such that the shaft 104 can slide within the handle end 108 from an extended position, illustrated in FIG. 1, to a retracted position, illustrated in FIG. 2. The handle end 108 is formed from the same material as the utensil head 112; therefore, the handle end 108 is sufficiently rigid, but also flexible and elastic. The handle end 108 includes an interior cavity 148 (outlined in FIG. 6), a slot 156 (FIG. 6), and a tab 160 each of which are explained below.

The interior cavity 148, illustrated in FIG. 6, has virtually the same dimensions as the exterior dimensions of the shaft 104, due to the method of manufacture. Specifically, the handle end 108 is formed by injecting molten polymer around the exterior of the shaft 104. Thus, the shaft 104 is slideably positioned in the interior cavity 148 of the handle end 108, as explained in further detail below with reference to the process 700 for manufacturing the utensil 100. The interior cavity 148 permits the shaft 104 to extend from and retract into the handle end 108. When extended, the handle end 108 increases the total length of the eating utensil 100 such that the dimensions of the utensil 100 in the unfolded configuration are very similar to the dimensions of a traditional stainless steel spoon, thereby making the eating utensil 100 comfortable to hold. When retracted, the handle end 108 encompasses most of the shaft 104, thereby decreasing the total length of the utensil 100 and making the utensil 100 easier to package.

The slot 156 is formed in the bottom of the handle end 108, as illustrated in FIG. 6. The slot 156 is sized to have a width approximately equal to the handle detent 132, which is a projection from the bottom of the shaft 104 that prevents the shaft 104 from being completely withdrawn and removed from the handle end 108. The length of the slot 156 determines the distance the shaft 104 extends from the handle end 108. Note that the position of the handle detent 132 ensures that a considerable portion of the shaft 104 remains within the handle end 108 even when the shaft 104 is in the unfolded position to give the utensil 100 stability. Specifically, when the utensil 100 is in the unfolded configuration, the handle end 108 and the shaft 104 form a rigid member that does not bend or flex as the utensil 100 is used to pick up food.

The handle end 108 also includes a tab 160 that in conjunction with the elongated groove 128 of the shaft 104 prevents the shaft 104 from being retracted into the handle end 108 after the shaft 104 has been extended from the handle end 108. The tab 160 is sized such that when the utensil 100 is in the folded the configuration the tab 160 fills the sloped depression 124, which is an indentation in the top surface of the shaft 104 approximately the same size as the tab 160. As the shaft 104 is drawn from the handle end 108, the tab 160 slides out of the sloped depression 124, slightly deforming the upper surface of the handle end 108 in the process. The tab 160 then slides across the upper surface of the shaft 104 until it reaches the elongated groove 128. The elongated groove 128 is a channel having a depth slightly greater than the distance the tab 160 protrudes from the handle end 108, as best illustrated in FIG. 3. When the tab 160 reaches the elongated groove 128, the elasticity of the handle end 108 snaps the tab 160 into the groove 128 and the handle end 108 returns to its original shape. In embodiment illustrated, once the tab 160 is seated in the groove 128 the shaft 104 cannot be retracted into the handle end 108. Of course, a tab 160 retraction member (not illustrated) could be included to lift the tab 160 out of the groove 128 so that the shaft 104 can be retracted into the handle end 108.

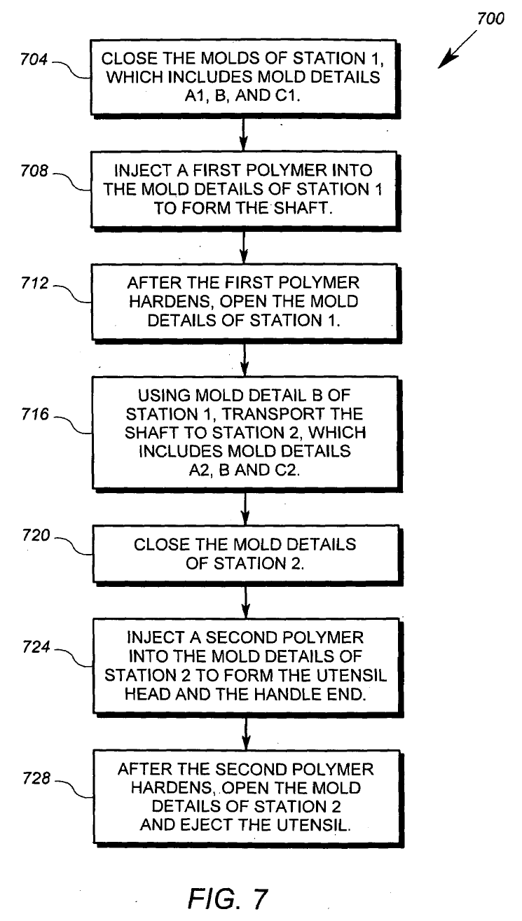

The utensil 100 may be produced using a multi-shot sequential injection molding (“SIM”) process 700 as illustrated in the flowchart of FIG. 7. Sequential injection molding enables manufacturers to inject at least two types of molten polymers or resins into a die, a mold, or a mold having multiple sections referred to as mold details. The injected polymers may have similar characteristics or may be quite different. For example, depending on the characteristics of the polymers, the molten polymers may bond together during the injection process. Alternatively, the polymers may remain separate both during and after the molding process.

In the present invention, two polymers are utilized to form the eating utensil 100. The first polymer is used to mold the shaft 104, and the second polymer is used to mold the handle end 108 and the utensil head 112. The polymers are chosen such that they are chemically incompatible and do not bond together during or after the molding process. Furthermore, injection of the second polymer does not impact the shape of the component or components formed by the first polymer. Suitable first polymers for molding the shaft 104 include, but are not limited to polystyrene, polyester, styrene acrylonitrile, or a suitable bioresin. Likewise, suitable second polymers for molding the handle end 108 and the utensil head 112 include, but are not limited to polypropylene, high density polyethylene, or a suitable bioresin. The specific molding process 700 utilized to form the eating utensil 100 is explained below.

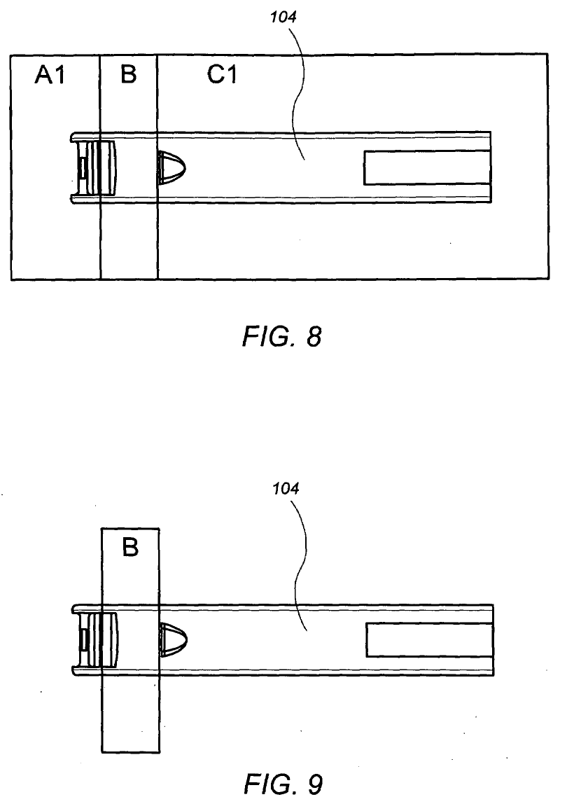

The molding process 700 begins at a first molding station having a mold with three mold details labeled A1, B, and C1, as illustrated in FIG. 8. To begin the process 700, the mold details of station 1 are closed (block 704) and molten polymer of the first type is injected into the mold details A1, B, C1, thereby forming the shaft 104 as illustrated in FIG. 8 (block 708). Once the polymer is no longer molten, the mold details of station 1 are opened (block 712). Using mold detail B of station 1, the rigid shaft 104 may be automatically transported to a second molding station, which includes mold details A2, B, and C2 (block 716). Specifically, an automated system lifts mold detail B and transports the mold detail to the second station. As illustrated in FIG. 9, mold detail B supports the shaft 104 during transport. The system then lowers mold detail B into the mold details of the second molding station. Thus, the process 700 may use the same mold detail B at both molding stations.

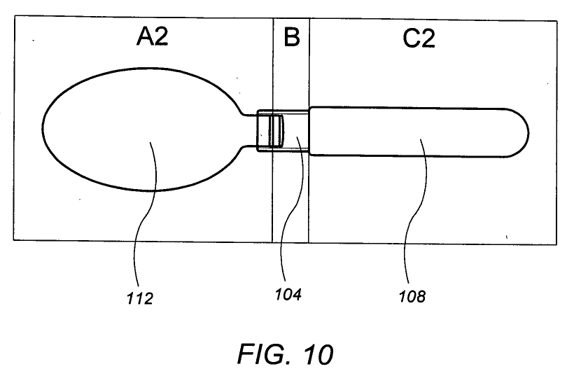

After the shaft 104 is transported to the second molding station, the mold details A2, B, and C2 are closed around the rigid shaft 104 (block 720). Next, the injection molding machine injects molten polymer of the second type around the outer surface of the shaft 104, as permitted by the mold details, thereby forming the utensil head 112 and handle end 108, as illustrated in FIG. 10 (block 724). As mentioned above, the polymers are chosen such that when the second polymer is injected into mold details A2, B, and C2 the first and second polymers do not bond together. After the second polymer is no longer molten, mold details A2, B, C2 can be opened and the eating utensil 100 can be ejected from the injection molding machine (block 724).

The eating utensil 100 is ejected from the mold details A2, B, C2 with the shaft 104 retracted into the handle end 108, and the utensil head 112 pivoted away from the handle end 108. Thus, before the eating utensil 100 may be packaged in the folded configuration, the utensil head 112 should be folded toward the handle end 108.

In another embodiment (not illustrated), the eating utensil 100 may be transported to the second molding station manually. Specifically, the shaft 104 may be molded in a first mold and then allowed to cool and become rigid. Next, the shaft 104 may be removed from the first mold and hand loaded into a second mold, which forms the handle end 108 and utensil head 112 as described above.

Although an eating utensil 100 has been described with respect to certain preferred embodiments, it will be appreciated by those of skill in the art that other utensil implementations and adaptations are possible. Moreover, there are advantages to individual advancements described herein that may be obtained without incorporating other aspects described above. Therefore, the spirit and scope of the appended claims should not be limited to the description of the preferred embodiments contained herein, and the claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants, patentees, and others.

What is claimed is:

1. An eating utensil comprising:
a handle comprising a first material; and
a utensil head formed from a second material, the utensil head moveably positioned on the first shaft.

2. The eating utensil of claim 1 wherein the handle is provided in the form of a first shaft.

3. The eating utensil of claim 2 further comprising a second shaft comprising a second material, the second shaft moveably positioned on the first shaft.

4. The eating utensil of claim 2, wherein the utensil head further comprises:
a bowl; and
a connection member pivotally connected to a first end of the first shaft.

5. The eating utensil of claim 3 further comprising:
an interior cavity provided within the second shaft, the interior cavity extending in a longitudinal direction of the second shaft and configured to permit the first shaft to slide within the interior cavity between a retracted configuration and an extended configuration.

6. The eating utensil of claim 5 further comprising:
a tab on the second shaft;
a depression in the first shaft configured to accept the tab when the first shaft is in the retracted configuration; and
a channel in the first shaft configured to accept the tab and non-releasably secure the first shaft in the extended configuration.

7. The eating utensil of claim 6 further comprising:
a slot in the second shaft; and
a protrusion on the first shaft configured to slide within the slot and prevent the first shaft from being removed from the interior cavity of the second shaft.

8. The eating utensil of claim 1 wherein the first material is chemically incompatible with the second material such that the first material does not bond to the second material during a molding process.

9. The eating utensil of claim 2 further comprising:
a pivot rod integrally formed on a first end of the first shaft;
a connecting member integrally formed on the utensil head, wherein the connecting member completely encircles the pivot rod such that the connecting member pivots about the pivot rod.

10. The eating utensil of claim 9, wherein the pivot rod further comprises:
a detent that releasably secures the utensil head in an unfolded configuration.

11. An eating utensil comprising:
a handle comprising of a first material; and
a utensil head comprising a second material, the utensil head moveably connected to the handle, wherein the handle and utensil head are formed by a multi-shot sequential injection molding process.

12. The eating utensil of claim 11 wherein the first material is chemically incompatible with the second material such that the first material does not bond to the second material during the sequential injection molding process.

13. The eating utensil of claim 11 wherein the handle comprises a first shaft portion and a second shaft portion, wherein the first shaft portion is comprised of the first material and the second shaft portion is comprised of the second material.

14. The eating utensil of claim 13 wherein the first shaft portion is slideable in relation to the second shaft portion.

15. The eating utensil of claim 11 wherein the handle includes a pivot rod integrally formed on a first end of the handle and wherein the utensil head includes a connecting member integrally formed on the utensil head, wherein the connecting member completely encircles the pivot rod and the connecting member pivots about the pivot rod.

16. The eating utensil of claim 11 wherein the utensil head comprises a spoon bowl.

17. A method of making an eating utensil comprising:
molding a handle comprising of a first material within a multi-component mold;
removing at least one component of the multi-component mold and leaving the molded handle within at least one remaining component of the multi-component mold;
and
molding a utensil head comprised of a second material using the at least one remaining component of the multi-component mold.

18. The method of claim 17 wherein molding the handle comprises molding a first shaft portion comprised of the first material and molding a second shaft portion comprised of the second material.

19. The method of claim 18 wherein first material is chemically incompatible with the second material such that the first material does not chemically bond to the second material.

20. The method of claim 17 wherein molding the handle and molding the utensil head comprises sequential injection molding using the first material and the second material.
